(19) United States
(12) Patent Application Publication
(10) Pub. No.: US 2003/0104737 A1
(43) Pub. Date: Jun. 5, 2003

(54) Rigid fabric sculpture and method of making

(76) Inventor: David Green, Pompano Beach, FL (US)

Correspondence Address: H. John Rizvi, Gold & Rizvi, P.A., Suite 450, 600 N. Pine Island Rd., Plantation, FL, 33324, US

(21) Appl. No.: 10/004,757

(22) Filed: Dec. 4, 2001

(51) Int. Cl. B32B 27/12; B32B 5/02; B32B 27/04; D03D 11/00; B32B 9/00

(52) U.S. Cl. 442/104; 442/59; 442/205

(57) ABSTRACT

A rigid fabric sculpture and method of making, such that the rigid fabric sculpture includes a three-dimensional fabric element coated with a decorative resin. The method includes supporting a fabric element on a temporary support structure, molding the fabric element in a desired configuration, and applying decorative resin to the fabric element.

### BACKGROUND OF THE INVENTION

1. Field of the Invention

The present invention relates generally to artistic sculptures, and more particularly, to a rigid fabric sculpture made from fabric items such as articles of clothing. The present invention is particularly configured as artistic sculptures capable of utilizing overly worn, damaged, torn, or otherwise unusable clothing to form a variety of different rigid three-dimensional sculptured items.

2. Description of the Prior Art

The art of sculpting conjures up images of rigid natural materials such as stone, metal, clay, or wood. As such, conventional sculptures have typically been associated with material-removing processes such as carving, picking, and chipping.

Artistic sculpture as an art form, however, has evolved substantially through the years and encompasses an ever-expanding quest for new forms of sculptured items and ornamental expression. In recent years, there is an increased demand on artists to defy conventional boundaries and utilize new materials in innovative and original ways. Along these lines, there is a need for sculptures that can dramatically astound viewers when seen in a finished configuration while maintaining a degree of mystery regarding the underlying techniques utilized.

Additionally, recent public awareness and sensitivity towards environmental issues has put an increased demand on artists to utilize materials in an environmentally conscientious and responsible manner. With concerns over conservation issues rising, there is an increased awareness and appreciation for artistic expression that utilizes recycled and reused man-made materials instead of depleting virgin natural resources. There is also a desire to have artistic sculptures that, although decorative in nature, are valuable for a variety of functional and utilitarian purposes.

Accordingly, there is an established need for an artistic sculpture capable of utilizing, if desired, overly worn, torn, damaged, or otherwise unusable clothing into a variety of different functional sculptured items that provide a striking and unconventional three-dimensional rigid artistic display.

### SUMMARY OF THE INVENTION

The present invention is directed to artistic sculptures, and more particularly, to a rigid fabric sculpture and the method of making such sculptures, wherein a striking and unconventional three-dimensional artistic display is provided. Along these lines, it is desirable to provide rigid fabric sculptures that, although aesthetically pleasing, are also capable of being used for a variety of functional and utilitarian purposes.

An object of the present invention is to provide a rigid fabric sculpture and method of making that is capable of utilizing overly worn, damaged, torn, or otherwise unusable clothing to form a variety of different rigid three-dimensional sculptured items.

A further object of the present invention is to provide a rigid fabric sculpture and method of making encompassing a striking and unconventional artistic display.

Another object of the present invention is to provide a rigid fabric sculpture and method of making that minimizes the use of virgin natural resources.

An additional object of the present invention is to provide a rigid fabric sculpture and method of making that is capable of utilizing and preserving articles of clothing.

In accordance with a first aspect of the invention, a rigid fabric sculpture and method of making is provided comprising a three-dimensional fabric element coated with a decorative resin.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a perspective view of the rigid fabric sculpture in accordance with an exemplary embodiment of the present invention;

FIG. 2 is a rear view of the rigid fabric sculpture in accordance with an exemplary embodiment of the present invention;

FIG. 3 is a partial cross-sectional view of the rigid fabric sculpture illustrated in FIG. 2 taken along line 3-3 in accordance with an exemplary embodiment of the present invention;

FIG. 4 is a left side view of the rigid fabric sculpture in accordance with an exemplary embodiment of the present invention;

FIG. 5 is a right side view of the rigid fabric sculpture in accordance with an exemplary embodiment of the present invention;

FIG. 6 is top view of the rigid fabric sculpture in accordance with an exemplary embodiment of the present invention;

FIG. 7 is a bottom view of the rigid fabric sculpture in accordance with an exemplary embodiment of the present invention;

Like reference numerals refer to like parts throughout the several views of the drawings.

### DETAILED DESCRIPTION OF THE PREFERRED EMBODIMENTS

Shown throughout the figures, the present invention is generally directed towards a rigid fabric sculpture, and the method of making such sculptures, wherein a striking and unconventional three-dimensional artistic display is provided. The present invention is particularly configured as an artistic sculpture capable of utilizing overly worn, damaged, torn, or otherwise unusable clothing to form a variety of different rigid three-dimensional sculptured items. The rigid fabric sculptures of the present invention, although decorative in nature, can be configured to serve a variety of functional and utilitarian purposes as described in more detail herein.

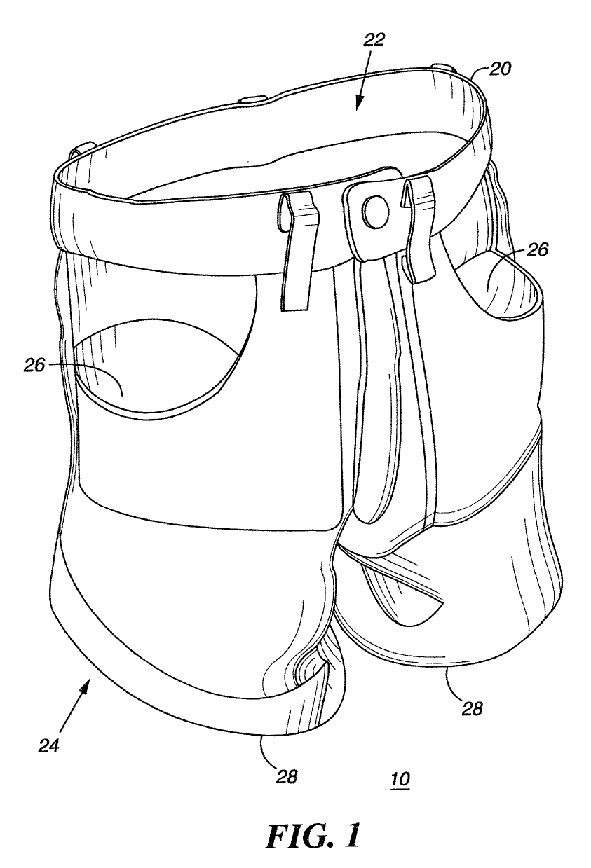

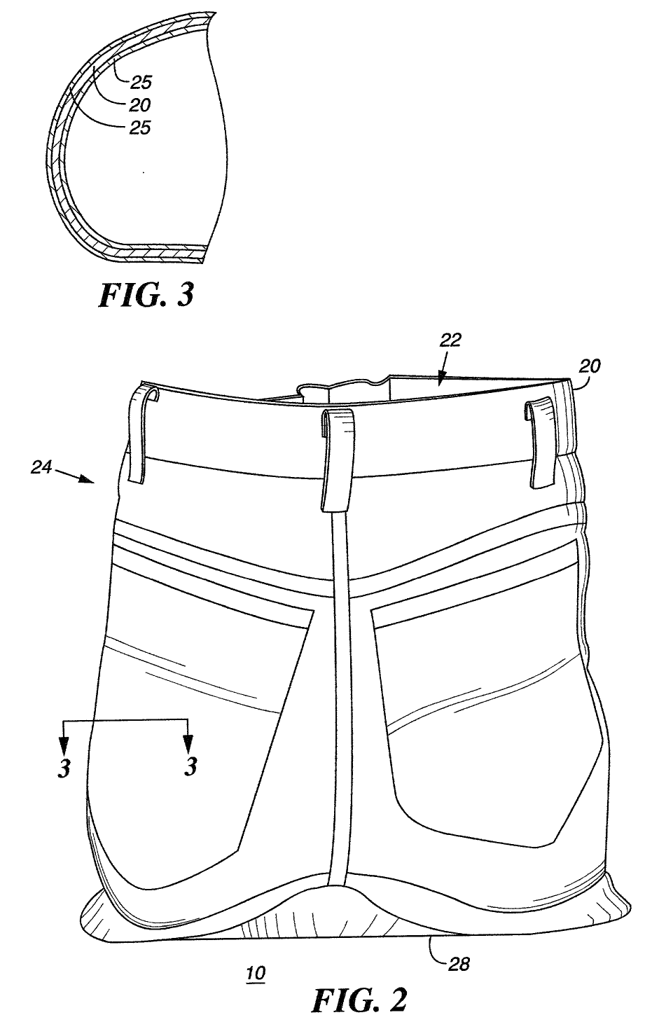

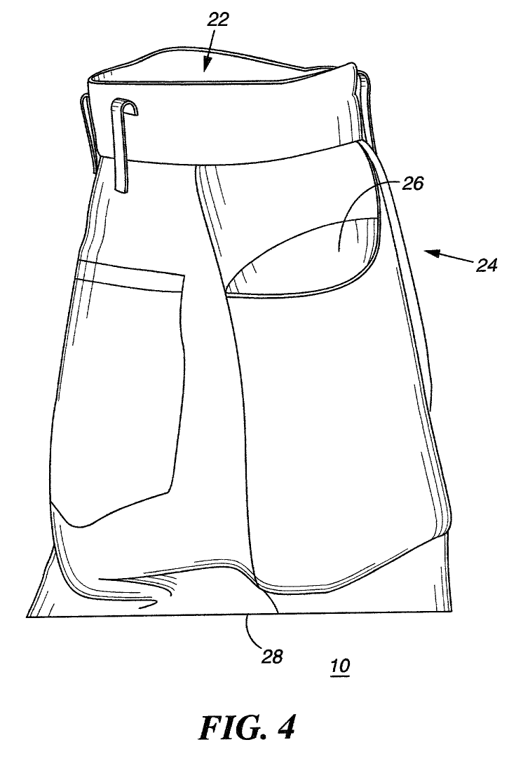

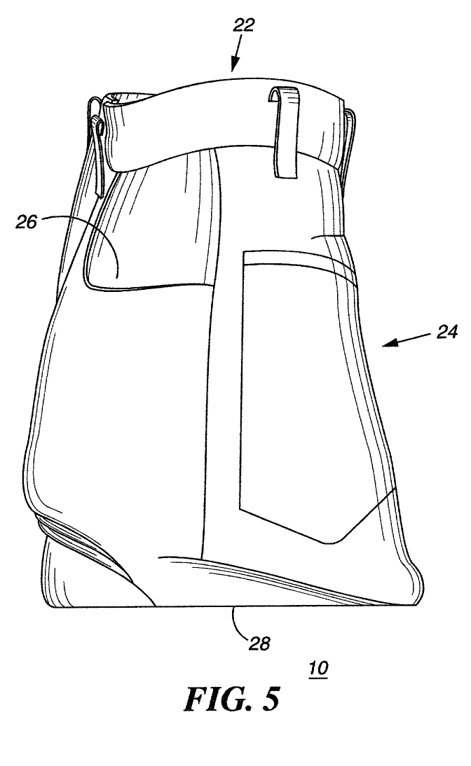

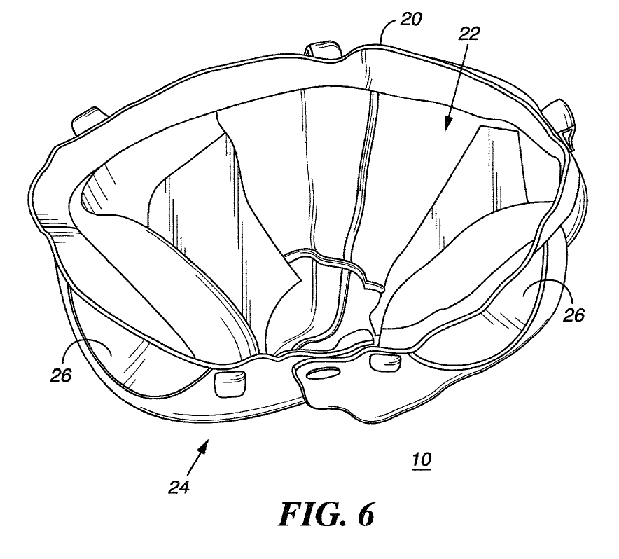

Referring now to FIGS. 1-7, one particular embodiment of a rigid fabric sculpture 10 is illustrated. The embodiment shown and described is exemplary only and is not intended to limit the invention. FIG. 1 illustrates a perspective view of a rigid fabric sculpture 10 of a preferred embodiment of the present invention.

As will become clear from the description below, an important component of the rigid fabric sculpture 10 of the present invention is a fabric element 20. The fabric element 20, as shown in the figures, may comprise any of a wide variety of known materials and configurations without departing from the present invention. In the preferred embodiment, the fabric element 20 is an article of clothing. In the specific embodiment illustrated in the figures, the fabric element 20 is a pair of denim jeans. Naturally, any of a known variety of other items of clothing or other fabric materials may be utilized, as described herein, without departing from the present invention. In the preferred embodiment, the fabric element 20 will be an item of clothing that is no longer suitable for use as clothing due to excessive wear, tears, defects, or other shortcomings. By recycling used clothing and other man-made materials, the rigid fabric sculptures 10 of the present invention prevent the irreversible depletion of virgin natural resources, reduce unnecessary waste, and save precious landfill space.

In the rigid fabric sculpture 10 of the present invention, the fabric element 20 includes an inner surface 22 and an outer surface 24 as shown in the figures. In the preferred embodiment, the inner and outer surfaces 22, 24 of the fabric element 20 are coated with a layer of decorative resin 25, as shown in the partial cross-sectional view of FIG. 3, to provide substantial rigidity to the fabric element 20 as well as a smooth decorative surface. In the preferred embodiment, the decorative resin is a clear epoxy decorative resin. A most preferred epoxy resin is manufactured by E-Bond Epoxies, Inc. of Fort Lauderdale, Fla. and sold as Decorative Resin No. 1225. If desired, a variety of colored dyes may be added to the decorative resin 25 for enhanced effect. It will be appreciated, however, by those skilled in the art, that any of a wide variety of other known materials may be utilized to coat the fabric element 20 without departing from the present invention.

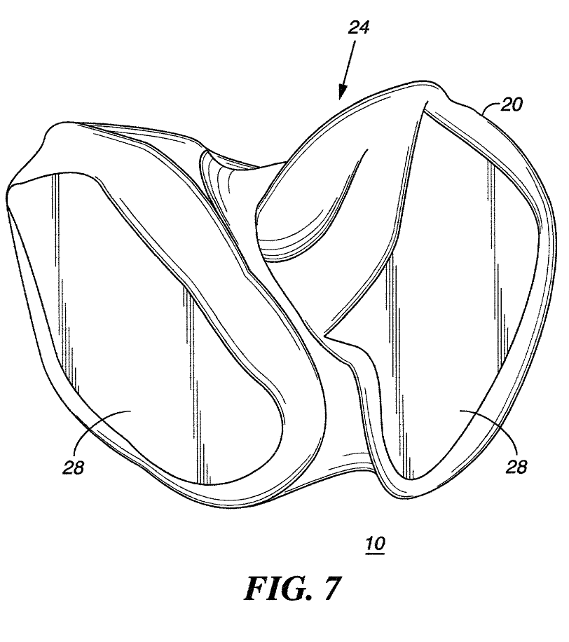

If desired, the rigid fabric sculpture 10 may also include a substantially hollow interior as shown in the figures. By providing a hollow interior, the rigid fabric sculpture 10 of the present invention can be utilized for a variety of functional and utilitarian purposes including use as a flower or plant pot, trash can, coin bank, or fruit bowl, to name a few illustrative examples. In order for the rigid fabric sculpture 10 to be of practical use for such purposes, however, it may be desirable to include a support base 28 as best shown in the bottom view of the rigid fabric sculpture 10 of FIG. 7. Additionally, pockets 26 in the fabric element 20 may be structured in an open configuration. Such a configuration enhances the decorative look of the rigid fabric sculpture 10 and can permit the pockets 26 to be used for storing a wide variety of small items.

Now that the rigid fabric sculpture 10 of the present invention has been described in depth, an illustrative method of making such sculptures will be explained. The rigid fabric sculpture 10 of the present invention is made by first supporting the fabric element 20 on an item configurable as a temporary support structure so as to prevent the fabric element 20 from shifting. The temporary support structure may include a metal clothes hanger, wire mesh structure, wooden frame, inflated balloon, and any of a wide variety of other known items. In some instances, it may be desirable to cover the temporary support structure with a non-adhesive material, such as a plastic wrapping material, to prevent the clear decorative resin from adhering to the temporary support structure.

Once the fabric element 20 is supported on the temporary support structure, it can be molded into a desired shape and the decorative resin applied. The decorative resin may be applied in a wide variety of ways without departing from the present invention. For example, the outer surface 24 of the fabric element 20 may be coated first and the decorative resin 25 allowed to dry and harden before applying the decorative resin 25 to the inner surface 22. It may be desirable in some circumstances to reverse this order and begin with the application of decorative resin 25 to the inner surface 22 of the fabric element 20. Additionally, it may be necessary to apply several coats of decorative resin 25 to the fabric element 20 of the rigid fabric sculpture 10 in order to achieve a desired thickness for the decorative resin 25.

Once the decorative resin 25 has dried and hardened, the temporary support structure may be removed. It may be desirable, at this point, to sand the outer surface 24 of the fabric element 20 and smooth out coarse edges. In addition to a final sanding, the decorative resin 25 may be sanded, if desired, between coats. After final sanding has taken place, a polyurethane coating is preferably applied over the decorative resin 25 to give the rigid fabric sculpture 10 a glossy appearance.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

I claim:

1. A method of making a rigid fabric sculpture comprising:
forming a temporary support structure;
supporting at least one fabric element on said temporary support structure;
molding said fabric element in a desired configuration;
applying a decorative resin to said fabric element;
allowing said decorative resin to dry and harden; and
sanding said decorative resin.

2. A method of making a rigid fabric sculpture, as recited in claim 1, further comprising the step of applying a polyurethane coating over said decorative resin.

3. A method of making a rigid fabric sculpture, as recited in claim 1, further comprising the step of applying a relatively non-adhesive material over said temporary support structure.

4. A method of making a rigid fabric sculpture, as recited in claim 2, wherein said temporary support structure is removed from said rigid fabric sculpture after said decorative resin has hardened.

5. A method of making a rigid fabric sculpture, as recited in claim 1, further comprising the step of applying a second coat of decorative resin.

6. A method of making a rigid fabric sculpture, as recited in claim 5, further comprising the step of fine sanding said second coat of decorative resin.

7. A method of making a rigid fabric sculpture, as recited in claim 6, further comprising the step of applying a polyurethane coating over said decorative resin.

8. A method of making a rigid fabric sculpture comprising:
forming a temporary support structure;
supporting at least one fabric element on said temporary support structure;
molding said fabric element in a desired configuration;
applying a decorative resin to an outer surface of said fabric element;
allowing said decorative resin to dry and harden;
removing said temporary support structure;
applying said decorative resin to an inner surface of said fabric element; and
sanding said decorative resin.

9. A method of making a rigid fabric sculpture, as recited in claim 8, further comprising the step of applying a relatively non-adhesive material over said temporary support structure;

10. A method of making a rigid fabric sculpture, as recited in claim 8, further comprising the step of applying a second coat of decorative resin.

11. A method of making a rigid fabric sculpture, as recited in claim 10, further comprising the step of fine sanding said second coat of decorative resin.

12. A method of making a rigid fabric sculpture, as recited in claim 11, further comprising the step of applying a polyurethane coating over said decorative resin.

13. A rigid fabric sculpture comprising a three-dimensional fabric element coated with a decorative resin.

14. A rigid fabric sculpture, as recited in claim 13, wherein said decorative resin is substantially clear.

15. A rigid fabric sculpture, as recited in claim 13, wherein said three-dimensional fabric element comprises an article of clothing.

16. A rigid fabric sculpture, as recited in claim 15, wherein said article of clothing is recycled from used clothing.

17. A rigid fabric sculpture, as recited in claim 17, wherein said outer surface of said rigid fabric sculpture has a substantially glossy appearance.

18. A rigid fabric sculpture, as recited in claim 17, wherein said outer surface of said rigid fabric sculpture comprises polyurethane.

19. A rigid fabric sculpture, as recited in claim 13, wherein said sculpture has a substantially hollow interior.

20. A rigid fabric sculpture, as recited in claim 13, wherein said decorative resin has been sanded.
